(19) United States
(12) Patent Application Publication
(10) Pub. No.: US 2026/0149168 A1
(43) Pub. Date: May 28, 2026

(54) Antenna Arrangement, Transceiver Arrangement, and Communication System

(71) Applicant: ROSENBERGER HOCHFREQUENZTECHNIK GMBH & CO. KG, Fridolfing (DE)

(72) Inventors: Reinhard Stolle, Aresing (DE); Markus Michael Theil, Haunstetten (DE)

(21) Appl. No.: 19/395,724

(22) Filed: Nov. 20, 2025

(30) Foreign Application Priority Data
Nov. 27, 2024 (EP) 24215648.7

(51) Int. Cl. H01Q 1/24; H01Q 21/06

(52) U.S. Cl. CPC H01Q 1/24; H01Q 21/065

(57) ABSTRACT

The antenna arrangement has a plurality of antennas, each designed to emit and simultaneously receive electromagnetic waves. Each antenna is arranged around a common centre axis. Associated centroids of directly adjacent antennas are equidistant from each other. Each antenna is respectively electrically and/or magnetically connected to at least one first signal line of the transceiver arrangement and at least one second signal line of the transceiver arrangement. In each antenna, the at least one first signal line in each case is respectively oriented orthogonally to the at least one second signal line. The signal lines are each designed in such a way that the first signal line transmits a transmission signal for the emitted electromagnetic wave and the second signal line transmits a reception signal of the received electromagnetic wave, or the first signal line transmits the reception signal and the second signal line transmits the transmission signal.

### FIELD OF THE INVENTION

The present invention relates to an antenna arrangement having a plurality of antennas.

The present invention further relates to a transceiver arrangement having an antenna arrangement, a transmitting unit and a receiving unit.

Finally, the present invention also relates to a communication system having two transceiver arrangements for providing wireless in-band full-duplex transmission between the transceiver arrangements.

### TECHNICAL BACKGROUND

For contactless or wireless data and/or energy transmission, an antenna arrangement consisting of one or more antennas is used. For simultaneous transmission and reception of electromagnetic waves (so-called full-duplex transmission mode), in particular for simultaneous transmission and reception of electromagnetic waves at the same frequency or in the same frequency band (so-called in-band full-duplex transmission mode), high electromagnetic attenuation or isolation between the transmitting and receiving channels within the same transceiver arrangement is essential in order to avoid crosstalk or interference between the transmitting and re-ceiving channels.

EP 4 150 708 B1 discloses an antenna arrangement, a transceiver arrangement and a communication system for in-band full-duplex transmission. The antenna arrangement has a transmitting antenna pair and a receiving antenna pair, each of which is fed symmetrically. In addition to the symmetrical feed, each receiving antenna has the same centre-to-centre distance with respect to both transmitting antennas in order to at least reduce the crosstalk between the transmitting antenna pair and the receiving antenna pair.

An antenna arrangement formed in this way and a transceiver arrangement, which has an antenna arrangement formed in this way, are preferably used in a communication system for wireless transmission between devices arranged so as to be movable with respect to each other, in particular between devices rotating about a common axis of rotation with respect to each other. This makes it possible, for example, to dispense with a common slip ring contact or a common connection cable.

In addition to the transmission of energy in the lower power range and data, the transmission of a hydraulic or pneumatic medium as well as energy in the higher power range in appropriate cables between the devices is often also required.

Between devices rotating with respect to each other, such cabling is usually guided in the area of the common axis of rotation. In an antenna arrangement according to EP 4 150 708 B1, cabling routed in this way is eliminated.

In addition, data transmission over a plurality of transmission channels each with different transmission protocols, for example high-speed data transmission in addition to data transmission with a shorter time requirement, is not possible in an antenna arrangement according to EP 4 150 708 B1. This together is a state which needs to be improved.

### DESCRIPTION OF THE INVENTION

Against this background, the present invention is based on the object of specifying an antenna arrangement, a transceiver arrangement and a communication system for wireless in-band full-duplex transmission, which has high isolation properties between the transmitter and the receiver within the same transceiver arrangement and additionally overcomes the aforementioned disadvantages.

According to the invention, this object is achieved by an antenna arrangement having the features as disclosed herein, by a transceiver arrangement having the features as disclosed herein and by a communication system having the features as disclosed herein.

The following is accordingly provided:

An antenna arrangement for a transceiver arrangement having
a plurality of antennas,
which are each designed to emit an electromagnetic wave and to simultaneously receive an electromagnetic wave,
wherein the plurality of antennas are each arranged around a common centre axis of the antenna arrangement, preferably along a common imaginary cylinder jacket around the common centre axis,
wherein associated centroids of directly adjacent antennas in each case are each arranged equidistantly from each other,
wherein each antenna is respectively electrically and/or magnetically connected to at least one first signal line of the transceiver arrangement and at least one second signal line of the transceiver arrangement,
wherein, in each antenna, the at least one first signal line in each case is respectively oriented orthogonally to the at least one second signal line, preferably the at least one first signal line in each case is oriented tangentially and the at least one second signal line in each case is oriented radially to the common centre axis,
wherein the at least one first signal line and the at least one second signal line are each designed in such a way that
i. the at least one first signal line transmits a transmission signal for the emitted electromagnetic wave and the at least one second signal line transmits a reception signal of the received electromagnetic wave, or
ii. the at least one first signal line transmits the reception signal and the at least one second signal line transmits the transmission signal.

The underlying finding/idea of the present invention in-volves, in an antenna arrangement, arranging a plurality of antennas, each of which is designed to emit an electromagnetic wave and to simultaneously receive an electromagnetic wave, in each case according to the invention around a common centre axis of the antenna arrangement, preferably along a common imaginary cylinder jacket around the common centre axis.

In order to compensate for the crosstalk between an electro-magnetic wave emitted by an antenna and an electromagnetic wave received by the same antenna at least partially, preferably completely, the polarization of the emitted electro-magnetic wave can be oriented orthogonally to the polarization of the received electromagnetic wave. The polarization must preferably be linear in each case both on the transmitting side and on the receiving side. Thus, as a further technical measure in each antenna, the at least one signal line of the transceiver arrangement, which in each case transmits the transmission signal to the respective antenna, can be oriented in each case orthogonally to the at least one signal line of the transceiver arrangement, which in each case transmits the reception signal from the respective antenna.

In order to compensate for the crosstalk between an electro-magnetic wave emitted by an antenna and the electromagnetic waves each received by the remaining antennas of the antenna arrangement at least partially, preferably completely, associated centroids of directly adjacent antennas in each case can finally be arranged equidistantly from each other as a further technical measure. In this way, there exist, along the common imaginary cylinder jacket around the common centre axis of the antenna arrangement relative to each reference antenna, in each case antenna pairs, the antennas of which are each at the same distance from the respective reference antenna. It is therefore possible to compensate at least partially, preferably completely, for the crosstalk of the electromagnetic wave received in each of the antennas of. an antenna pair to the electromagnetic wave emitted in the respective reference antenna. Conversely, it is likewise possible to compensate at least partially, preferably completely, for the crosstalk of the electromagnetic wave emitted in each of the antennas of an antenna pair to the electromagnetic wave received in the respective reference antenna. In an antenna arrangement having an odd number of antennas, the crosstalk between the individual antennas is thus compensated for in the best possible way. In an antenna arrangement having an even number of antennas, that antenna which is not assignable to such an antenna pair is furthest away from the respective reference antenna. The extent of the crosstalk of such an antenna to the respective reference antenna and thus the crosstalk in such an antenna arrangement can be compensated for at least partially, however, due to this fact.

The effect of said third technical measure according to the invention on the compensation for the crosstalk remains valid for each fixed or variable distance between the antenna arrangements of the two transceiver arrangements in the axial and/or lateral direction and for each fixed or variable phase offset between the antennas of the two transceiver arrangements, since the polarization of the electro-magnetic waves emitted in each case by all antennas of one transceiver arrangement is in each case oriented orthogonally to the polarization of the electromagnetic waves emitted in each case by all antennas of the other transceiver arrangement. Since the crosstalk is compensated for each phase offset between the antennas of the two transceiver arrangements of the communication system with the same quality, there is advantageously rotationally invariant compensation for the crosstalk by the antenna arrangement according to the invention.

Since the antennas of the antenna arrangement are each designed to emit and simultaneously receive an electromagnetic wave, i.e. constitute a so-called monostatic antenna, and are arranged equidistantly along a common imaginary cylinder jacket around the common centre axis of the antenna arrangement, an antenna arrangement, a transceiver arrangement and a communication system can be implemented with pressure and energy lines which can each be advantageously routed within the antenna arrangement of the two transceiver arrangements. In a further advantageous embodiment of an antenna arrangement, a transceiver arrangement and a communication system, it is possible to implement wireless transmission between the two transceiver arrangements of the communication system using two transmission channels in which a different transmission protocol is implemented. Arranged at the centre of the further advantageous embodiment of an antenna arrangement is an antenna arrangement having a transmitting antenna pair and a receiving antenna pair according to EP 4 150 708 B1 for fast data transmission. Grouped around this antenna arrangement is preferably an antenna arrangement according to the invention having antennas arranged equidistantly along a common imaginary cylinder jacket for data transmission at a reduced data rate.

The antenna arrangement is an antenna array, a group antenna, or a “group antenna element”. The antennas of the antenna arrangement are preferably each in the form of a directional antenna. A directional antenna is understood here and below as meaning an antenna with a directivity. In the case of a transmitting antenna, the transmitted energy is concentrated here in a certain direction, while, in the case of a receiving antenna, the maximum sensitivity is in a certain direction. In the case of the antennas of the antenna arrangement belonging to a transceiver arrangement, which each emit an electromagnetic wave and simultaneously receive an electromagnetic wave, the highest transmission power and the highest reception sensitivity are in each case preferably directed parallel to the centre axis of the antenna arrangement in the direction of the antenna arrangement of the other transceiver arrangement. In other words, the antennas of the antenna arrangement may be oriented such that their antenna main lobes each point in the same direction, namely parallel to the centre axis of the antenna arrangement in the direction of the antenna arrangement of the other transceiver arrangement. The directivity of an antenna is described by its antenna gain. This is often shown in a directional diagram in spherical coordinates on the basis of the elevation angle and the azimuth angle. In a directional diagram, the so-called “antenna lobes” are then obtained by the alternation of maxima and minima of the antenna gain, wherein the antenna lobe, which comprises the global maximum of the antenna gain, is referred to as the “antenna main Lobe”.

Essentially, all basic geometric shapes of directional antennas, in particular of linearly polarized directional antennas, such as planar antennas, parabolic antennas, horn antennas, waveguide antennas, shell antennas, dipole antennas etc., can be used. Preferably, each antenna of the antenna arrangement has the same basic geometric antenna shape and/or the same mechanical and electrical dimensioning. The material of the antenna and the position of the feed-in point and/or the feed-out point of the antenna are also identical. In principle, however, the antennas of the arrangement may also have a different structure, but preferably at least a similar structure.

In principle, the invention may be suitable for transmitting any electromagnetic waves with any wavelengths or frequencies. However, the invention is particularly advantageously suitable for transmitting radio-frequency electromagnetic waves in the frequency range between 20 GHZ and 66 GHZ, preferably between 24 GHZ and 24.25 GHz (narrowband transmission in the ISM band with a bandwidth of 250 MHZ) or alternatively between 57 GHZ and 66 GHZ (broadband transmission in a band with a bandwidth of 9 GHZ that is reserved for near-field transmission). Due to the high carrier frequencies, a high data transmission rate can result during short-range signal transmission, preferably in the near-field range of the antenna arrangement, which allows particularly advantageous suitability of the proposed antenna arrangement for contactless electrical connectors for replacing conventional electrical plug-in connections.

Each antenna of the antenna arrangement is, preferably with its centroid, respectively arranged along a single common imaginary cylinder jacket around the common centre axis of the antenna arrangement. In particular, no antenna is preferably arranged with its centroid within the single common imaginary cylinder jacket and very preferably no antenna is preferably arranged with its centroid on the centre axis of the antenna arrangement. The centre axis of the antenna arrangement is also referred to below as a common axis of rotation, provided that the two transceiver arrangements of the communication system with their associated antenna arrangements rotate relative to each other about the common axis of rotation. The centroid of the antenna is the centre of mass of the antenna. The equidistant distance between the centroids of directly adjacent antennas of the antenna arrangement in each case, in combination with the fact that the centroids of the antennas are arranged along a single common imaginary cylinder jacket around the common centre axis of the antenna arrangement, results in an equidistant phase angle between directly adjacent antennas of the antenna arrangement in each case for all pairs of directly adjacent antennas in each case relative to the centre axis of the antenna arrangement.

Since each antenna respectively simultaneously emits an electromagnetic wave and receives an electromagnetic wave, each antenna is respectively connected to at least one signal line, which in each case feeds the transmission signal for the electromagnetic wave to be emitted into the antenna, and to at least one signal line, which in each case feeds the reception signal of the received electromagnetic wave out of the antenna. Since the polarization of the emitted electromagnetic wave is oriented orthogonally to the polarization of the received electromagnetic wave in order to minimize the crosstalk, the at least one signal line of the transceiver arrangement, which in each case transmits the transmission signal, is oriented orthogonally to the at least one signal line of the transceiver arrangement, which in each case transmits the reception signal.

Thus, in the transceiver arrangement, a group of signal lines which are each connected to the individual antennas and are referred to here and below as first signal lines can be oriented orthogonally to another group of signal lines which are each connected to the individual antennas and are referred to here and below as second signal lines. In the case of antennas of an antenna arrangement, which are arranged along a common imaginary cylinder jacket around the common centre axis of the antenna arrangement, the group of first signal lines each connected to the individual antennas can thus be oriented tangentially to the centre axis of the antenna arrangement. The other group of second signal lines each connected to the individual antennas can be oriented radially to the centre axis of the antenna arrangement.

In a first variant of the antenna arrangement, the at least one first signal line respectively transmits the transmission signal for the electromagnetic wave to be emitted by the respective antenna and the at least one second signal line respectively transmits the reception signal of the electromagnetic wave received by the respective antenna. In an alternative, second variant of the antenna arrangement, the at least one first signal line respectively transmits the reception signal of the electromagnetic wave received by the respective antenna and the at least one second signal line respectively transmits the transmission signal for the electromagnetic wave to be emitted by the respective antenna.

The connection between the at least one first signal line and the respective antenna, and between the at least one second signal line and the respective antenna, is effected electrically and/or magnetically in each case. In the case of an electrical connection between the first or second signal line and the respective antenna, galvanic coupling or capacitive coupling is possible. In the case of a magnetic connection between the first or second signal line and the respective antenna, inductive coupling is realized by means of a transformer, for example. An electrical and magnetic connection between the first or second signal line and the respective antenna can be effected via electromagnetic near-field coupling. This can be coupling-in and coupling-out via an intermediate antenna or a stacked arrangement of intermediate antennas, which can be arranged in each case in an associated plane between the antenna and an earth plane of the electrical printed circuit board.

Each antenna of the antenna arrangement can be connected in each case to at least one first signal line and at least one second signal line. A single first signal line or a single second signal line can each transmit an asymmetrical signal, which is also referred to as a single-ended signal. Signal lines of a pair of first signal lines or a pair of second signal lines can each be arranged on opposite sides of the respective antenna and each transmit a symmetrical or differential signal.

Advantageous configurations and developments are evident from the description with reference to the figures.

It goes without saying that the features mentioned above and the features yet to be explained below can be used not only in the respectively specified combination but also in other combinations or alone, without departing from the scope of the present invention.

Asymmetrical feeding-in of a transmission signal or asymmetrical feeding-out of a reception signal can cause a shift from a linear polarization into a slight cross-polarization of the electromagnetic wave due to geometry and/or material tolerances of the antenna or of the feed-in point or feed-out point relative to the antenna. In order to minimize or eliminate the crosstalk caused by this between the signal lines, the feeding-in and feeding-out between the respective antenna and the associated first signal lines can be symmetrical or differential in each case in a preferred embodiment of the invention. The two first signal lines thus transmit a symmetrical or differential signal. Compared to asymmetrical feeding-in or feeding-out, symmetrical feeding-in or feeding-out can align the polarization of the electromagnetic wave in the direction of an imaginary connecting line between the two feed-in points or between the two feed-out points and can thus promote the formation of a linearly polarized electromagnetic wave. In addition, there is an additional isolation mechanism due to the uniform crosstalk in terms of magnitude and phase to the differential signal lines.

In one preferred embodiment of the invention, a feed-in point or feed-out point for the associated symmetrical signal can also be formed in each antenna of each pair of directly adjacent antennas in each case, which points are arranged closely adjacent to each other within the respective pair and at each of which an electrical potential of the associated symmetrical signal is present, the phases of which are in phase opposition to each other.

In particular, the individual transceiver arrangement may be designed such that transmission signals can each be fed into the symmetrical feed-in points of directly adjacent antennas in each case, the electrical potentials of which transmission signals have the above-mentioned phase relationship or polarities.

In particular, in the case of first signal lines, which are oriented tangentially to the centre axis of the antenna arrangement, such a polarity of the electrical potentials at the feed-in points or feed-out points between the individual antennas and the associated first signal lines means that, relative to each reference antenna of the antenna arrangement, the crosstalk of the electrical potentials at the feed-in or feed-out points of the other antennas to the respective reference antenna can be mutually compensated for in each case (with the exception of a possibly existing antenna with a maximum distance to the reference antenna, whose crosstalk cannot be compensated for with the crosstalk of any other antenna of the antenna arrangement).

In this way, in a first variant of the antenna arrangement, the crosstalk of the transmission signals from the feed-in points of the first signal lines into the individual associated antennas to the reception signals at the feed-out points of the remaining antennas to the associated second signal lines and vice versa can be compensated for. Similarly, in a second variant of the antenna arrangement, the crosstalk of the reception signals at the feed-out points of the individual antennas into the associated first signal lines to the transmission signals at the feed-in points of the second signal lines to the remaining antennas and vice versa can be compensated for.

In one particularly preferred embodiment of the invention, each antenna can be connected in each case to a single second signal line of the transceiver arrangement, which can preferably be oriented radially relative to the centre axis of the antenna arrangement and can be arranged either radially on the inside or radially on the outside relative to the respective antenna. The single second signal line is fed with an asymmetrical signal, i.e. a single-ended signal.

Crosstalk of transmission or reception signals, which are fed into the associated antennas or fed out from the associated antennas at the feed-in or feed-out points of symmetrical and tangentially oriented first signal lines, to feed-in or feed-out points of symmetrical and radially directed second signal lines cannot be completely compensated for, since the distances from the feed-in and feed-out points of the tangentially directed first signal lines to the radially outer feed-in and feed-out points are different to the distances from the feed-in and feed-out points of the tangentially directed first signal lines to the radially inner feed-in and feed-out points.

Preferably, the at least one second signal line, preferably the single second signal line, can be directed in each case to the centroid of the respective antenna. The feed-in and feed-out path of the signal transmitted in each case in the at least one second signal line, which can thus be oriented both radially to the centre point of the antenna arrangement and radially to the centroid of the respective antenna, forms an axis of symmetry for the feeding-in and feeding-out of the signal transmitted in the two first signal lines. Due to the equidistant distances between the individual antennas, the symmetry relative to the radial feed-in or feed-out path of a respective reference antenna also applies to the feeding-in and feeding-out of the signals fed in and out tangentially in the other antennas in each case. Such a preferred design of the individual antennas thus results in the best possible compensation for the crosstalk between the electromagnetic wave emitted and received in the same antenna as well as between the electromagnetic waves respectively emitted and received in different antennas.

For each antenna, the associated at least one first signal line, or the associated preferably two first signal lines, can each be advantageously directed to the centroid of the respective antenna. However, it is also conceivable to feed the signal transmitted in the at least one first signal line in and out with a feed-in and feed-out path offset with respect to the centroid of the respective antenna. Such feeding-in and feeding-out, which is asymmetrical to the centroid of the antenna, need not worsen the compensation for the crosstalk. However, compensation for the crosstalk can be improved by the first signal lines of each antenna preferably being arranged in each case at the same radial distance from the centre point of the antenna arrangement.

The feed-in and feed-out point of the at least one first signal line and of the at least one second signal line can preferably be formed off-centre within the cross-sectional edge of the individual antenna. However, it is also conceivable to feed the at least one first signal line and the at least one second signal line in and out in each case at the cross-sectional edge or slightly outside the cross-sectional edge of the individual antenna. A shift in the input impedance at the feed-in or feed-out point in the first and third cases compared to the second case can be compensated for by appropriate matching in a matching network.

In a further preferred embodiment of the invention, the antennas can each have the same cross-sectional geometry and/or the same cross-sectional area in a direction orthogonal to the centre axis of the antenna arrangement in order to realize antennas with the same resonant frequency.

In addition, for each antenna, a maximum extent in a direction radial to the centre axis of the antenna arrangement and a maximum extent in a direction tangential to the centre axis of the antenna arrangement can preferably be the same in each case. Thus, in each antenna, the resonant frequency of the electromagnetic wave, which is fed in or out by the at least one tangentially extending first signal line, corresponds in each case to the resonant frequency of the electromagnetic wave, which is fed in or out by the at least one radially extending second signal line. In this way, the transmission between the two transceiver arrangements is advantageously matched in both transmission directions.

An antenna with a circular cross section best meets this technical requirement due to the rotational symmetry with respect to its centroid. A square or a polygonal antenna, each with an axis of symmetry of the same length in a radial direction and in a tangential direction with respect to the centre point of the antenna arrangement, may alternatively be used.

In a further preferred embodiment of the invention, each antenna can in each case be in the form of a planar antenna. Here and below, a “planar” antenna should be understood as meaning an antenna with a predominantly flat and a preferably level shape having in particular two main surfaces facing away from each other, preferably extending in a parallel manner, that is to say for example in the form of a disc, a coating or a small plate. In particular, a planar antenna can be a patch antenna or a slot antenna. The planar antennas of the antenna arrangement can each preferably be arranged on a side surface of an electrical printed circuit board or on a plane of the electrical printed circuit board parallel to the side surface. A planar antenna which is arranged at a distance from the electrical printed circuit board and is fixed to the electrical printed circuit board is also conceivable.

The electrical printed circuit board is preferably produced from the composite material FR-4 (composite material made of glass fibres in epoxy resin) or from a composite of ceramic particles (Teflon) in epoxy resin and thus enables a cost-effective implementation of the antenna arrangement. An implementation in which the planar antennas of the antenna arrangement are integrated directly on the substrate of an integrated circuit, and are thus packed very closely to the further technical functional units of the transceiver arrangement (transmitting and receiving unit, balancing element, etc.), is also conceivable.

The at least one first signal line and/or the at least one second signal line can each be in the form of a strip line and can be arranged on the same side surface or in the same plane of the electrical printed circuit board as the associated planar antenna. Alternatively, the at least one first signal line and/or the at least one second signal line may each be formed on a different side surface or plane of the electrical printed circuit board than the planar antenna. In this case, the connection can be effected galvanically using a via in each case or capacitively, inductively or electro-magnetically.

Particularly preferably, each planar antenna of the antenna arrangement may be arranged on the same side surface or in the same plane of the electrical printed circuit board or of the integrated circuit that is parallel to the side surface. The planar antennas can preferably be arranged along a common imaginary circumference on a side surface or on a plane of the electrical printed circuit board or of the integrated circuit that is parallel thereto. The common imaginary circumference is arranged on the above-mentioned cylinder jacket relative to a centre point or a centre of rotation of the antenna arrangement, which is located at the intersection of the common centre axis of the antenna arrangement with the side surface or the plane of the electrical printed circuit board or of the integrated circuit that is parallel thereto. Such a particularly preferred embodiment of the invention in each case standardizes the crosstalk between the individual antennas of the antenna arrangement and thus additionally optimizes the compensation for the crosstalk. The distances between directly adjacent planar antennas in each case, which can be arranged along a circular line on a side surface or a plane of the electrical printed circuit board or of the integrated circuit that is parallel thereto, can preferably also be equidistant in order to compensate for the crosstalk at least partially and preferably completely.

In order to achieve minimum compensation for the crosstalk between the antennas of the antenna arrangement, the antenna arrangement may have at least three antennas. As already explained in detail above, an odd number of antennas compared to an even number of antennas in the antenna arrangement achieves better compensation for the crosstalk. In the antenna arrangement, a higher number of antennas, i.e. a finer raster of the antennas in the antenna arrangement, achieves a better transmission quality compared to a smaller number of antennas, since the receiving antennas can always each be located within the main lobe of an opposite transmitting antenna. However, the number of antennas realized in an antenna arrangement ultimately depends heavily on the application, i.e. the available installation space, the required transmission quality and the implementation budget. Thus, an antenna arrangement can preferably have at least five antennas and particularly preferably at least seven antennas. It is impossible to touch the individual antennas within the antenna arrangement.

In one preferred development of the invention, the transmission signal can be fed into each antenna in each case by the associated at least one first signal line (i.e. in a first variant of the antenna arrangement) or by the associated at least one second signal line (i.e. in a second variant of the antenna arrangement) in each case in phase. Here and below, in-phase feeding-in means that the electrical potentials of the transmission signals, which are each in the form of an alternating signal, preferably each in the form of a radio-frequency alternating signal, each have the same phase in each case at the feed-in point of the at least one first signal line or of the at least one second signal line into the associated antenna. The transmission signals fed into all antennas in each case are identical here and thus have the same carrier and the same modulation signal.

Such in-phase feeding of an identical transmission signal into each antenna of the antenna arrangement advantageously makes it possible to emit in-phase electromagnetic waves along the entire annular emission plane of the antenna arrangement. The electromagnetic wave received in each case in the antennas of the opposite antenna arrangement or transceiver arrangement thereby experiences only a phase shift caused by the phase distortion in the transmission channel, which is also independent of the rotation angle due to the rotational symmetry of the transmission channel. Thus, the equalization in the receiving transceiver arrangement can be advantageously simplified or the equalization quality can be advantageously improved.

An additional improvement in the equalization can be achieved by virtue of the transmission signal being fed into each antenna in each case by the associated at least one first signal line or by the associated at least one second signal line, preferably in each case in phase and in each case with the same amplitude.

The invention further also covers a transceiver arrangement having an antenna arrangement according to the invention, a transmitting unit, a receiving unit, a signal branching unit and a signal combining unit.

An output terminal of the transmitting unit is connected here to an input terminal of the signal branching unit and an output terminal of the signal combining unit is connected to an input terminal of the receiving unit.

In addition, in the first variant of the antenna arrangement, the output terminals of the signal branching unit are each connected to the at least one first signal line of the associated antenna, and the second signal lines of each antenna are each connected to an associated input terminal of the signal combining unit. In the second variant of the antenna arrangement, the output terminals of the signal branching unit are each connected to the at least one second signal line of the associated antenna, and the first signal lines of each antenna are each connected to the associated input terminal of the signal combining unit.

The technical features, technical effects and technical advantages each mentioned above and below for the antenna arrangement apply equivalently to the transceiver arrangement and vice versa.

In an advantageous manner, it is possible to provide a transceiver arrangement having an antenna arrangement, which is suitable for simultaneous bidirectional data transmission (full duplex) in the same frequency band (in-band full duplex). In addition, irrespective of mutual rotation or a mutual rotational orientation of the antenna arrangements each belonging to the two transceiver arrangements, it is possible to compensate for crosstalk between the transmitting channel and the receiving channel in the best possible way with a simultaneously simple and thus cost-minimized technical structure of the antenna arrangement.

The connection between the individual units can be effected here in each case directly or, as will be explained, indirectly by interposing at least one further unit. The connection is preferably effected electrically here via an associated electrical signal line, for example via a strip line suitable for RF applications. In a less preferred embodiment, the connection between the individual units can also be effected magnetically via a transformer, for example, or via electromagnetic near-field coupling.

The transmitting unit is designed to generate a transmission signal, preferably a radio-frequency transmission signal.

The signal branching unit, at the input terminal of which the transmission signal received from the transmitting unit is present, is designed to split the radio-frequency transmission signal present at the input terminal into a number of transmission signals corresponding to the number of the antennas of the antenna arrangement at a respective output terminal. The transmission signals present at each of the output terminals are preferably identical and are each reduced with regard to their signal level at least by the di-vision factor of the signal branching unit (-number of output terminals) compared to the signal level of the transmission signal at the input terminal. The signal branching unit (splitter) can preferably be in the form of a radio-frequency power splitter, also referred to as a 0° coupler, in the forms of a resistive power splitter, a reactive power splitter-also called a Wilkinson power splitter or λ/4 power splitter-or a hybrid power splitter. The signal branching unit can also be implemented as an active power splitter which is preferably implemented in an integrated circuit. In a less preferred embodiment, the signal branching unit can also be in the form of a resistive signal splitter. In the case of a Wilkinson power splitter, due to the in-phase transmission signals at the individual output terminals, it is possible to dispense with a normally used output resistor between the two output terminals of each final splitter stage.

In the transmission signal path, the transmission signal generated by the transmitting unit is multiplied using the signal branching unit. The multiplied and identical transmission signals are supplied to the individual antennas via the respective signal lines (first signal lines in the first variant of the antenna arrangement and second signal lines in the second variant of the antenna arrangement).

In the reception signal path, the reception signals fed out into the respective signal lines of the individual antennas (second signal lines in the first variant of the antenna arrangement and first signal lines in the second variant of the antenna arrangement) are combined in the signal combining unit and are supplied to the receiving unit.

The signal combining unit can be implemented according to the same above-mentioned technical principles as the signal branching unit. Only the signal combining unit is connected in the reverse signal flow direction to the signal branching unit. The receiving unit is designed to obtain the information transmitted in the reception signal in usual signal processing stages (amplification, filtering, equalization, demodulation, etc.).

In a first variant of one preferred development of a transceiver arrangement, which is referred to here and below as a first transceiver arrangement, the output terminals of the signal branching unit can each be connected to an asymmetrical terminal of a balancing element which belongs to the respective antenna and is referred to here and below as a first balancing element. The symmetrical terminals of the first balancing element may be connected to a pair of first signal lines of the respective antenna.

In a second variant of one preferred development of a transceiver arrangement, which is referred to here and below as a second transceiver arrangement, a pair of first signal lines of each antenna can be respectively connected to symmetrical terminals of a further balancing element which belongs to the respective antenna and is referred to here and below as a second balancing element. The asymmetrical terminal of each second balancing element may be connected to the associated input terminal of the signal combining unit.

A symmetrical terminal is understood here and below as meaning a terminal of symmetrical or differential signal transmission. An asymmetrical terminal is understood here and below as meaning a terminal for asymmetrical or single-ended signal transmission.

In a communication system according to the invention, the transceiver arrangement of one communication partner is in the form of the first transceiver arrangement and the transceiver arrangement of the other communication partner is in the form of the second transceiver arrangement.

The individual first balancing element of the first transceiver arrangement is respectively designed to convert an asymmetrical transmission signal into a symmetrical transmission signal for feeding a differential transmission signal into the individual antenna. The individual second balancing element of the second transceiver arrangement is respectively designed to convert a reception signal fed out in each case differentially or symmetrically from an individual antenna into an asymmetrical reception signal.

The first or the second balancing element can preferably be in the form of a 180° coupler, also referred to as a hybrid coupler or rat-race coupler. In addition, a balun, preferably a Marchand balun or a balun in the form of an autotransformer, can be used in each case as the first or second balancing element in a less preferred embodiment.

The symmetrical terminals of the individual first and second balancing elements are each connected to the associated pairs of first signal lines of the individual antennas in such a way that the electrical potentials of two symmetrical signals, which are present at the two closely adjacent feed-in or feed-out points of a pair of directly adjacent antennas, are in phase opposition or have a different polarity.

In an alternative embodiment of the first transceiver arrangement, the asymmetrical terminal of a first balancing element can be connected to the output terminal of the transmitting unit. The two symmetrical terminals of the first balancing element can each be connected to the input terminal of two signal branching units. In each case, an output terminal of the two signal branching units can be connected to an associated first signal line of a pair of first signal lines for feeding a differential transmission signal into an associated antenna. In an equivalent manner, in an alternative embodiment of the second transceiver arrangement, the first signal lines, connected to a respective antenna, of a pair of first signal lines for feeding out a differential reception signal can be connected to an associated input terminal of two signal combining units. The output terminals of the two signal combining units may be connected to the symmetrical input terminals of a second balancing element, the output terminal of which may be connected to the input terminal of the receiving unit.

The invention finally also covers a communication system having a first transceiver arrangement and a second transceiver arrangement for providing wireless in-band full-duplex transmission between the transceiver arrangements.

The first transceiver arrangement is designed to emit a first electromagnetic wave belonging to a first transmission signal. The second transceiver arrangement is designed to receive the first electromagnetic wave emitted by the first transceiver arrangement and to convert it into an associated first reception signal. In addition, the second transceiver arrangement is designed to emit a second electromagnetic wave belonging to a second transmission signal. The first transceiver arrangement is additionally designed to receive the second electromagnetic wave emitted by the second transceiver arrangement and to convert it into an associated second reception signal.

The first and the second transceiver arrangement are each designed as described above. In addition, the technical features, technical effects and technical advantages mentioned above and below for the antenna arrangement and for the transceiver arrangement apply equivalently to the communication system and vice versa.

In an advantageous manner, it is possible to provide a cost-effective and installation-space-minimized in-band full-duplex communication system for wireless data transmission between the communication partners with optimized compensation for the crosstalk between the transmitting channel and the receiving channel. On the one hand, the communication system can be used for communication partners in a fixed position with respect to each other. On the other hand, the communication system displays its transmission quality in particular in the case of electrical devices that can be moved with respect to each other, in particular can be moved rotationally with respect to each other, or in the case of electrical devices with a fixed, but unknown, phase offset between the antennas of the antenna arrangements each belonging to the two transceiver arrangements. The communication system according to the invention can be used in particular as a slip ring or cabling replacement for rotating motors, generators, machines, automatons or robots, for example in the automotive, industrial, energy generation and medical technology sectors.

In one preferred embodiment of the communication system, the two transceiver arrangements can be rotated relative to each other about a common axis of rotation, The common axis of rotation can here coincide with the centre axes of the antenna arrangement respectively belonging to the two transceiver arrangements. The common centre point of each antenna arrangement composed of planar antennas in each case is thus located on the common axis of rotation in each case.

In addition to a rotational relative movement, a translational relative movement, in particular in the direction of the common axis of rotation, between the two communication partners can also be provided.

In a further preferred embodiment of the communication system, the cylinder jacket, along which each antenna of the first transceiver arrangement is arranged in each case, can be aligned with the cylinder jacket, along which each antenna of the second transceiver arrangement is arranged in each case. In the case of antenna arrangements having planar antennas in each case, the associated circular lines of the two antenna arrangements, along which the centre points of the individual planar antennas are arranged, can be arranged coaxially to each other and can each have the same diameter. Thus, the annular regions in which the antennas of the two transceiver arrangements are arranged in each case can be aligned with each other. In a main emission lobe of each antenna in the two transceiver arrangements, which is directed in each case parallel to the orientation of the common axis of rotation, the emitting antennas of one transceiver arrangement can thus be aligned in the best possible manner with the receiving antennas of the other transceiver arrangement.

In one advantageous development of the communication system, the first signal lines in the first transceiver arrangement can each be designed to transmit the first transmission signal, and the first signal lines in the second transceiver arrangement can consequently each be designed to transmit the associated first reception signal. Thus, the electromagnetic waves respectively emitted by each transmitting antenna of the first transceiver arrangement each have a polarization oriented tangentially to the common axis of rotation.

Due to the tangential orientation of the first signal lines of each receiving antenna in the second transceiver arrangement, the receiving antennas each have a maximum reception sensitivity in the direction tangential to the common axis of rotation and can thus receive the electromagnetic waves respectively emitted by the first transceiver arrangement in the best possible way in each case with a tangentially oriented polarization. The transmitting antennas of the first transceiver arrangement thus have the same symmetry as the receiving antennas of the second transceiver arrangement.

Equivalently, the second signal lines in the second transceiver arrangement can each be designed to transmit the second transmission signal, and the second signal lines in the first transceiver arrangement may consequently each be designed to transmit the associated second reception signal.

The electromagnetic wave respectively emitted by each transmitting antenna of the second transceiver arrangement respectively has a polarization oriented radially to the common axis of rotation. The electromagnetic wave respectively emitted by each transmitting antenna of the second transceiver arrangement is received in the best possible way by each receiving antenna of the first transceiver arrangement, since its maximum reception sensitivity is in each case oriented radially to the common axis of rotation due to the radial orientation of the at least one second signal line of each receiving antenna. The transmitting antennas of the second transceiver arrangement thus likewise have the same symmetry as the receiving antennas of the first transceiver arrangement.

The first transceiver arrangement and the second transceiver arrangement can preferably be arranged with respect to each other in the near-field range of the associated antenna arrangements. The communication system according to the invention has, in particular in the near-field range, an electric field rotationally symmetrical in each case to the common axis of rotation or the centre axes of the two antenna arrangements and is thus suitable in particular for rotationally invariant data transmission between two communication partners.

Here and below, a near-field range is understood as meaning an axial distance between the two transceiver arrangements of the order of magnitude of up to three wavelengths, preferably of up to two wavelengths, of the signal to be transmitted. In the case of a suitable transmission frequency range of the wireless in-band full-duplex transmission of the communication system according to the invention of between 20 GHz and 66 GHZ, the preferred near-field range is at an axial distance between the two transceiver arrangements of between 1.5 mm and 5 mm. However, wireless in-band full-duplex transmission at a greater axial distance between the two transceiver arrangements is also conceivable. Preferably, the axial distance between the first transceiver arrangement and the second transceiver arrangement may be less than 10 cm, particularly preferably less than 5 cm, and very particularly preferably less than 1 cm.

The above configurations and developments can be combined with one another in any desired manner, insofar as is feasible. Further possible configurations, developments and implementations of the invention also encompass not explicitly mentioned combinations of features of the invention described above or below with respect to the exemplary embodiments. In particular, in this case, a person skilled in the art will also add individual aspects as improvements or supplementations to the respective basic form of the present invention.

### DRAWINGS

The present invention is explained in greater detail below on the basis of the exemplary embodiments indicated in the drawings, in which:

FIGS. 1A, 1B show top views of an antenna arrangement according to the invention,

FIG. 2 shows a representation of the directional characteristic of an antenna arrangement according to the invention,

FIG. 3 shows a cross-sectional representation of an antenna arrangement according to the invention,

FIG. 4A shows a top view of two antenna arrangements rotated with respect to each other,

FIG. 4B shows a sectional representation of a communication system according to the invention having two antenna arrangements, FIGS. 5A, 5B show block diagrams of two variants of a transceiver arrangement according to the invention,

FIG. 6 shows a top view of a combination of two different antenna arrangements for wireless full-duplex data transmission, and

FIG. 7 shows an isometric representation of an antenna arrangement according to the invention having further centrally routed lines.

The accompanying figures of the drawing are intended to con-vey a further understanding of the embodiments of the invention. They illustrate embodiments and, in association with the description, serve to explain principles and concepts of the invention. Other embodiments and many of the advantages mentioned will become apparent from the drawings. The elements in the drawings are not necessarily shown in a manner true to scale in relation to one another.

In the figures of the drawing, identical, functionally identical and identically acting elements, features and components are each provided with the same reference signs, unless stated otherwise.

The figures are described in an interrelated and comprehensive manner below.

### DESCRIPTION OF EXEMPLARY EMBODIMENTS

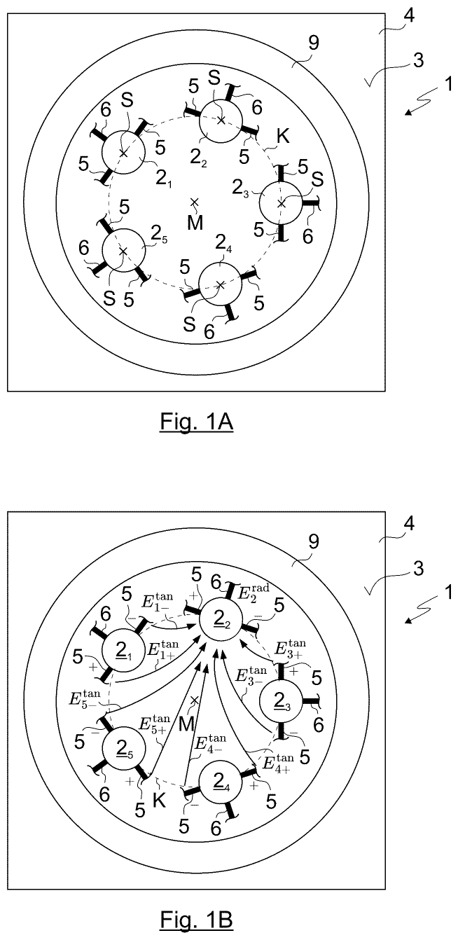

FIG. 1A shows a top view of an antenna arrangement 1 consisting of a plurality of individual antennas 2₁, 2₂, 2₃, 2₄, 2₅ which are in the form of patch antennas and are fixed on a side surface 3 of an electrical printed circuit board 4. The individual patch antennas are arranged equidistantly with their centroid S, which is at the same time their centre point, on a circular line K around a centre point M of the antenna arrangement 1. Each individual antenna 2 has, for example, a round cross section. However, it is also conceivable to have any other geometry of the antenna 2₁, 2₂, 2₃, 2₄, 2₅, which is in each case symmetrical to a radial beam running, in each case beginning from the centre point M of the antenna arrangements 1, through the respective centroid S of the individual antenna 2₁, 2₂, 2₃, 2₄, 2₅. In addition, the transverse extent of each individual antenna 2 is preferably identical.

Each antenna 2₁, 2₂, 2₃, 2₄, 2₅ is respectively connected to a pair of first signal lines 5, each transmitting a symmetrical or differential signal. The two first signal lines 5 each have a tangential orientation with respect to the centre point M of the antenna arrangement 1. The feed-in or feed-out points of the two first signal lines 5 into the respective antenna or from the respective antenna 2₁, 2₂, 2₃, 2₄, 2₅ are preferably arranged symmetrically with respect to the centroid S of the respective antenna 2₁, 2₂, 2₃, 2₄, 2₅. Preferably, the feed-in or feed-out points of the two first signal lines 5 are arranged within the edge of the respective antenna 2₁, 2₂, 2₃, 2₄, 2₅. However, they may also be arranged at the edge of the respective antenna 2₁, 2₂, 2₃, 2₄, 2₅ or slightly outside the edge of the respective antenna 2₁, 2₂, 2₃, 2₄, 2₅. Each antenna 2₁, 2₂, 2₃, 2₄, 2₅ is additionally connected to a second signal line 6 which in each case transmits an asymmetrical or single-ended signal. The second signal lines 6 each have a radial orientation with respect to the centre point M of the antenna arrangement 1. The second signal lines 6 can each be arranged either radially outside the respective antenna 2₁, 2₂, 2₃, 2₄, 2₅, as shown in FIG. 1A, or radially inside the respective antenna 2₁, 2₂, 2₃, 2₄, 2₅. The feed-in or feed-out points of the individual second signal lines 6 into the respective antenna or from the respective antenna 2₁, 2₂, 2₃, 2₄, 2₅ can preferably also be arranged within the edge of the respective antenna 2₁, 2₂, 2₃, 2₄, 2₅ or at the edge or slightly outside the edge of the respective antenna 2₁, 2₂, 2₃, 2₄, 2₅.

In a first variant of an antenna arrangement 1, the pairs of first signal lines 5 can each feed a transmission signal, preferably an in-phase transmission signal with the same signal amplitude in each case, into the respective antenna 2₁, 2₂, 2₃, 2₄, 2₅ for the emission of a corresponding electromagnetic wave. In the first variant of an antenna arrangement 1, the second signal lines 6 can each feed a reception signal from the respective antenna 2₁, 2₂, 2₃, 2₄, 2₅, which reception signal corresponds to the received electro-magnetic wave from the respective antenna 2₁, 2₂, 2₃, 2₄, 2₅. Due to the orthogonal arrangement of the pair of first signal lines 5 with respect to the second signal line 6 for each antenna 2₁, 2₂, 2₃, 2₄, 2₅, the polarization of the electromagnetic wave emitted by a respective antenna 2₁, 2₂, 2₃, 2₄, 2₅ is orthogonal to the polarization of the electromagnetic wave received by the same antenna 2₁, 2₂, 2₃, 2₄, 2₅. Crosstalk between the emitted electromagnetic wave and the received electromagnetic wave within an individual antenna 2₁, 2₂, 2₃, 2₄, 2₅ is thus compensated for at least partially, preferably completely. In a second variant of an antenna arrangement 1, the two first signal lines 5 each transmit the reception signal of the respective antenna 2₁, 2₂, 2₃, 2₄, 2₅, while the second signal lines 6 each transmit the transmission signal of the respective antenna 2₁, 2₂, 2₃, 2₄, 2₅.

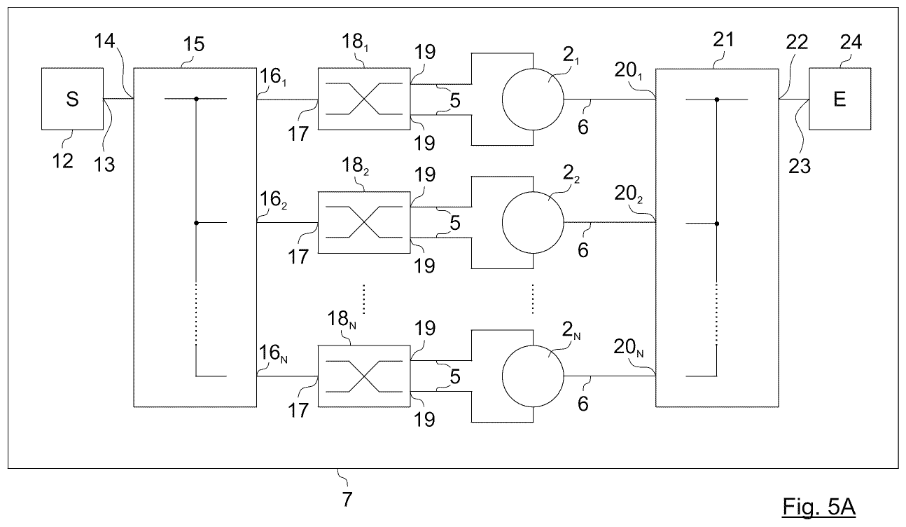

In order to attenuate, in a communication system 8 (see FIG. 4B in this respect) comprising two transceiver arrangements 7 and 7′ which communicate with each other and each have an antenna arrangement 1 and 1′, reflections of electromagnetic waves between the two antenna arrangements 1 and 1′, a layer 9 of an absorber material is preferably annularly applied, around the antenna arrangement 1, to the same side surface 3 of the electrical printed circuit board 4 on which the individual patch antennas are also arranged.

Partial or preferably complete compensation for the cross-talk of emitted electromagnetic waves and of received electromagnetic waves between the individual antennas 2₁, 2₂, 2₃, 2₄, 2₅ is explained schematically with reference to the antenna arrangement 1 in FIG. 1B as follows. Here, the cross-talk between emitted and received electromagnetic waves in relation to the antenna 2₂ is explained by way of example:

A reception signal, which corresponds to the received electromagnetic wave of the antenna 2₂ and has an electrical potential E^{rad}₂ at a certain time, is fed out of the antenna 2₂ via the radially oriented second signal line 6. In the tangentially oriented pairs of the first signal lines 5, a symmetrical or differential transmission signal is respectively fed into the respective antenna 2₁, 2₂, 2₃, 2₄, 2₅. The preferably in-phase and/or amplitude-identical transmission signals are fed in at each antenna 2₁, 2₂, 2₃, 2₄, 2₅ in each case in such a way that the electrical potential of the differential transmission signal at the closely adjacent feed-in and feed-out points of a respective pair of directly adjacent antennas respectively has the same amplitude and an opposite phase, i.e. a phase difference of 180°. Thus, the transmission signal at the feed-in point of the antenna 2₁, which is positioned directly adjacent to the antenna 2₂, has an electrical potential Etam-and the transmission signal at the feed-in point, which is also positioned directly adjacent to the antenna 2₂, has an equal electrical potential E^{tan}₃₊ with an opposite phase. In addition, the distances between these feed-in points of the transmission signals into the antennas 2₁ and 2₃ and the feed-out point of the wave received by the antenna 2₂ are equal in each case.

The transmission signal at the other feed-in point of the antenna 2₁, which is positioned further away from the antenna 2₂, has an electrical potential E^{tan}₁₊ and the transmission signal at the other feed-in point of the antenna 2₃, which is also positioned further away from the antenna 2₂, has an equal electrical potential E^{tan}₃₋ with an opposite phase. In addition, the distances between these feed-in points of the transmission signals into the antennas 2₁ and 2₃ and the feed-out point of the wave received by the antenna 2₂ are also equal in each case, Due to the equal distances between the closely adjacent feed-in points of the antennas 2₁ and 2₃ and the feed-out point of the reference antenna 2₂ and the amplitude identity and the opposite phase of the transmission signals at the two feed-in points of the antennas 2₁ and 2₃ closely adjacent to the reference antenna 2₂ and the equal distances between the further distant feed-in points of the antennas 2₁ and 2₃ and the feed-out point of the reference antenna 2₂ and the amplitude identity and the opposite phase of the transmission signals at the two feed-in points of the antennas 2₁ and 2₃ further away from the reference antenna 2₂, the electro-magnetic waves which are each emitted by the two antennas 2₁ and 2₃ and have crosstalk to the reference antenna 2₂ compensate for each other at the feed-out point of the electromagnetic wave received by the reference antenna 2₂.

The same applies to the crosstalk of the electromagnetic waves emitted by the antennas 2₄ and 2₅ to the feed-out point of the electromagnetic wave received by the reference antenna 2₂:
The electrical potential E^{tan}₄₊ of the transmission signal fed in at the feed-in point of the antenna 2₄, which is positioned closely adjacent to the feed-out point of the reference antenna 2₂, has the same amplitude as and the opposite phase to the electrical potential E^{tan}₅₋ of the transmission signal fed in at the feed-in point of the antenna 2₅, which is positioned closely adjacent to the feed-out point of the reference antenna 2₂. The distances between the feed-in points of the antennas 2₄ and 2₅ closely adjacent to the feed-out point of the reference antenna 2₂ and the feed-out point of the reference antenna 2₂ are identical.

The transmission signal at the other feed-in point of the antenna 2₄, which is positioned further away from the reference antenna 2₂, has an electrical potential E^{tan}₄₋ and the transmission signal at the other feed-in point of the antenna 2₅, which is also positioned further away from the antenna 2₂, has an equal electrical potential E^{tan}₅₊ with an opposite phase. In addition, the distances between these feed-in points of the transmission signals into the antennas 2₄ and 2₅ and the feed-out point of the wave received by the antenna 2₂ are also equal in each case.

Thus, the electromagnetic waves respectively emitted by the antennas 2₄ and 2₅ and the electromagnetic waves that have crosstalk to the feed-out point of the reference antenna 2₂ compensate for each other in an equivalent manner to that for the antenna pair 2₁ and 2₃ at the feed-out point of the reference antenna 2₂.

The relationship of the crosstalk shown in FIG. 1B for the reference antenna 2₂ applies equivalently to the crosstalk to the other antennas 2₂, 2₃, 2₄ und 2₅. In addition, this relationship also applies to the crosstalk of the electromagnetic wave respectively emitted by individual reference antennas to the electromagnetic waves respectively received in the other antennas. The compensation for the crosstalk respectively shown in FIG. 1B for the second variant of the antenna arrangement 1 also applies equivalently to the first variant of the antenna arrangement 1.

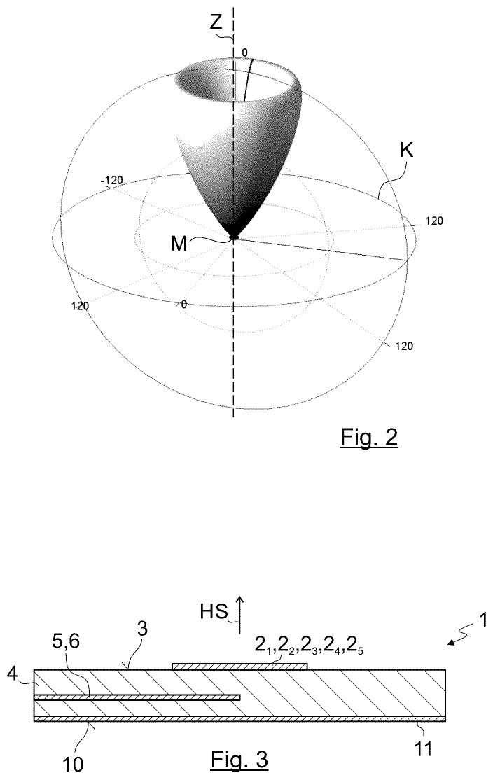

In particular, the in-phase, i.e. phase-coherent, and amplitude-identical feeding of the same transmission signal into all antennas 2₁, 2₂, 2₃, 2₄, 2₅ of the antenna arrangement 1 according to the invention results in a rotationally symmetrical directional characteristic around a centre axis Z of the antenna arrangement 1 in the near-field range of. the antenna arrangement 1 according to FIG. 2. This rotationally symmetrical directional characteristic only enables wireless in-band full-duplex transmission in mutually phase-shifted antennas of two mutually fixed antenna arrangements 1 or of two mutually rotating antenna arrangements 1 of two intercommunicating transceiver arrangements 7 and 7′ of a communication system 8. This provides functional rotationally invariant wireless in-band full-duplex transmission between the antenna arrangements 1 and 1′ of two opposite transceiver arrangements 7 and 7′ according to the invention of a communication system 8 according to the invention.

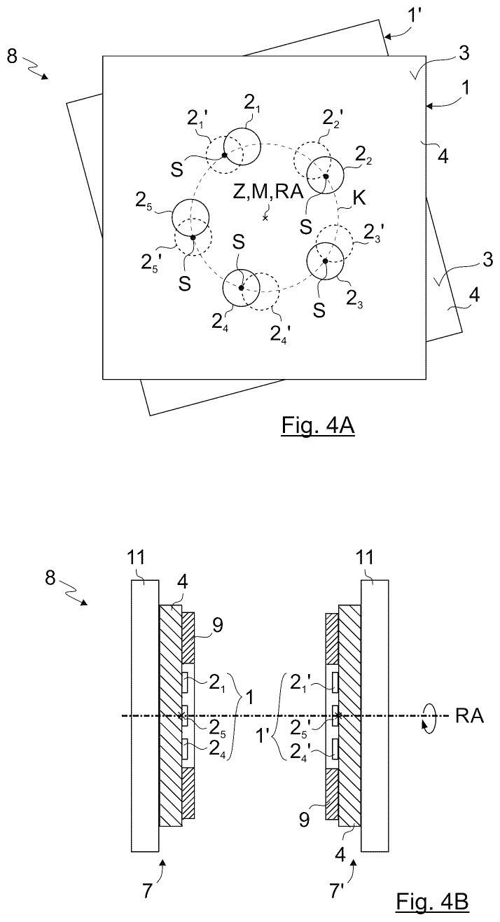

An exemplary section of an antenna arrangement 1 emerges from the cross-sectional representation in FIG. 3: One of the planar antennas 2₁, 2₂, 2₃, 2₄, 2₅, which is in the form of a patch antenna by way of example, is applied to a side surface 3 (here the upper side surface) of the electrical printed circuit board 4. In a conventional procedure, a metallized layer 11 is provided as an earth or reference plane on the opposite side surface 10 (here the lower side surface) of the electrical printed circuit board 4 and preferably orients the electromagnetic wave emitted by the respective planar antenna 2₁, 2₂, 2₃, 2₄, 2₅ in the direction of the main beam direction HS of the antenna arrangement 1. The transmission or reception signal is fed into or from the respective planar antenna 2₁, 2₂, 2₃, 2₄, 2₅ via a pair of first signal lines 5 or alternatively via a second signal line 6 which in each case in FIG. 3 is, for example, in the form of. a signal line within the electrical printed circuit board 4 between the metallized earth layer 11 and the respective planar antenna 2₁, 2₂, 2₃, 2₄, 2₅. The coupling between the respective planar antenna 2₁, 2₂, 2₃, 2₄, 2₅ and the pair of first signal lines 5 or alternatively the second signal line 6 is capacitive in the representation in FIG. 3. Alternatively, galvanic coupling via an electrically conductive via between the respective planar antenna 2₁, 2₂, 2₃, 2₄, 2₅ and the feed-in or feed-out line is also possible. Alternatively, electromagnetic near-field coupling can also be implemented via intermediate antennas each in the form of a metallic layer between the planar antenna 2 and the feed-in or feed-out line.

The rotation of the antennas 2₁, 2₂, 2₃, 2₄, 2₅ of a first antenna arrangement 1 with respect to the antennas 2₁′, 2₂′, 2₃′, 2₄″, 2₅′ (shown in dashed lines) of a second antenna arrangement 1′ around a common axis of rotation RA can be seen schematically from FIG. 4A in a plan view. The common axis of rotation RA coincides here with the respective centre axes Z of the two antenna arrangements 1 and 1′, but this does not necessarily have to be the case. Thus, the circles or circular lines K, on which the centroids S of the antennas 2₁, 2₂, 2₃, 2₄, 2₅ of the first antenna arrangement 1 and the centroids of the antennas 2₁′, 2₂′, 2₃′, 2₄′, 2₅′ of the second antenna arrangement 1′ are arranged in each case, are aligned with each other. The centre points M of these two circles K are thus also arranged opposite each other. The arrangement of the antennas 2₁, 2₂, 2₃, 2₄, 2₅ within an annular portion of the first antenna arrangement 1, which is aligned with an annular portion of the second antenna arrangement 1′, in which the antennas 2₁, 2₂, 2₃, 2₄′, 2₅′ of the second antenna arrangement 1 are arranged, enables, in combination with the rotationally symmetrical design of the electric field in the near-field range of the first and the second antenna arrangement 1 and 1′, reflection-minimized wireless in-band full-duplex data transmission between the two transceiver arrangements 7 and 7′ of the communication system 8.

A communication system 8 according to the invention comprising a first transceiver arrangement 7 and a second transceiver arrangement 7″, which can each be rotated about a common axis of rotation RA relative to each other, emerges from the cross-sectional representation in FIG. 4B. In this case, the first transceiver arrangement 7 can be in the form of a first variant of a transceiver arrangement yet to be explained and the second transceiver arrangement 7′ can be in the form of a second variant of a transceiver arrangement yet to be explained. The two transceiver arrangements 7 and 7′ each have an antenna arrangement 1 and 1′ of individual antennas 2₁, 2₂, 2₃, 2₄, 2₅ and 2₁′, 2₂′, 2₃′, 2₄′, 2₅′ which are applied to an electrical printed circuit board 4 and are surrounded by a layer 9 of absorber material which is also applied annularly to the electrical printed circuit board 4. In addition to the antenna arrangement 1 and 1′, the two transceiver arrangements 7 and 7′ each have additional technical functional units which are also explained in the following figures and are preferably arranged on a further electrical printed circuit board 4.

A first variant of a transceiver arrangement or a first transceiver arrangement 7 according to FIG. 5A has a transmitting unit 12 which is designed to generate a transmission signal. The transmission signal is referred to here and below as a first transmission signal. An output terminal 13 of the transmitting unit 12 is connected to the input terminal 14 of a signal branching unit 15, preferably electrically, particularly preferably galvanically. The signal branching unit 15 is designed to generate, from the first transmission signal received at the input terminal 14, a number N of identical first transmission signals corresponding to the number N of antennas 2, which signals are each present at the individual output terminals 16₁, 16₂, . . . , 16_{N}. The signal branching unit 15 is preferably in the form of a radio-frequency power splitter, particularly preferably in the form of a Wilkinson power splitter.

The individual output terminals 16₁, 16₂, . . . , 16_{N} of the signal branching unit 15 are each connected to an asymmetrical terminal 17 of an associated first balancing element 18₁, 18₂, . . . , 18_{N}. The individual first balancing element 18₁, 18₂, . . . , 18_{N} of the first transceiver arrangement 7 is respectively designed to convert the asymmetrical or single-ended first transmission signal present at the respective asymmetrical terminal 17 into a symmetrical or differential first transmission signal respectively present at the symmetrical terminals 19. The individual first balancing elements 18₁, 18₂, . . . , 18_{N} are preferably each implemented as 180° couplers or ring couplers. The symmetrical terminals 19 of the individual first balancing elements 18₁, 18₂, . . . , 18_{N} are each connected, via a pair of first signal lines 5, to feed-in points of an associated antenna 2₁, 2₂, . . . , 2_{N}. The individual antennas 2₁, 2₂, . . . , 2_{N} each emit an electromagnetic wave corresponding to the first transmission signal.

The electromagnetic waves respectively received by the individual antennas 2₁, 2₂,., 2_{N} are fed out, at an associated feed-out point, into the second signal line 6 connected to the respective antenna 2₁, 2₂, . . . , 2_{N} as an asymmetrical or single-ended reception signal. The reception signal respectively fed out from the individual antennas 2₁, 2₂. . . . , 2_{N} of the first transceiver arrangement 7 into the associated second signal line 6 is referred to here and below as the second reception signal, since it corresponds to the second transmission signal sent by the second transceiver arrangement 7′.

The second signal lines 6 each connected to the feed-out points of the individual antennas 2₁, 2₂, . . . , 2_{N} of the first transceiver arrangement 7 are routed to associated input terminals 20₁, 20₂, . . . , 20_{N} of a signal combining unit 21. The signal combining unit 21 is designed to add or combine the second reception signals respectively present at the individual input terminals 20₁, 20₂, . . . , 20_{N} to form a common second reception signal and to output it at the output terminal 22. The output terminal 22 of the signal combining unit 21 is connected to the input terminal 23 of the receiving unit 24. The receiving unit 24 is designed to obtain the information contained in the second reception signal using further signal processing steps.

In order to align in each case the polarization of the transmitting antennas 2₁, 2₂, . . . , 2_{N} of the first transceiver arrangement 7 with the polarization of the receiving antennas 2₁′, 2₂′, . . . , 2_{N}′ of the second transceiver arrangement 7′ and to align the polarization of the receiving antennas 2₁, 2₂, . . . , 2_{N} of the first transceiver arrangement 7 with the polarization of the transmitting antennas 2₁″, 2₂″, . . . , 2_{N}′ of the second transceiver arrangement 7′, a second transceiver arrangement 7′ according to FIG. 5B is modified compared to the first transceiver arrangement 7 according to FIG. 5A:

The second transmission signal generated by the transmitting unit 12 of the second transceiver arrangement 7′ is transmitted via its output terminal 13 to the input terminal 14 of the signal branching unit 15. The signal branching unit 15 is designed to multiply the single second transmission signal at input terminal 14 into a number of second transmission signals corresponding to the number N of antennas 2₁′, 2₂′, . . . , 2_{N}′ of the second transceiver arrangement 7′ and to output them at the output terminals 16₁, 16₂, . . . , 16_{N}. The second transmission signals present at the output terminals 16₁, 16₂, . . . , 16_{N} of the signal branching unit 15 of the second transceiver arrangement 7′ are fed directly as asymmetrical second transmission signals via an associated second signal line 6 into the respective feed-in point of the associated antenna 2₁′, 2₂′, 2₃′, 2₄′, 2₅′ of the second transceiver arrangement 7′ and are each emitted as electromagnetic waves. The electromagnetic waves respectively received by the individual antennas 2₁′, 2₂′, 2₃′, 2₄′, 2₅′ of the second transceiver arrangement 7′ are each fed out at the respective pairs of feed-out points into the associated pair of first signal lines 5 as symmetrical or differential first reception signals (since they correspond to the first transmission signals of the first transceiver arrangement 7). The respective pairs of first signal lines 5 are connected to the symmetrical terminals 19 of the associated second balancing elements 18₁, 18₂, . . ., 18_{N}.

The second balancing elements 18₁, 18₂, . . . , 18_{N} of the second transceiver arrangement 7′ are each designed to convert the symmetrical second reception signal at the symmetrical input terminals 19 into an associated asymmetrical second reception signal at the respective symmetrical output terminal 17. The symmetrical output terminals 17 of the individual balancing elements 18₁, 18₂, . . . , 18_{N} are connected to associated input terminals 20₁, 20₂, . . . , 20_{N} of the signal combining unit 21. The signal combining unit 2₁ of the second transceiver arrangement 7′ is designed to add or combine the second reception signals respectively present at the individual input terminals 20₁, 20₂, . . . 20_{N} to form a single second reception signal at the output terminal 22. The single second reception signal at the output terminal 22 of the signal combining unit 21 is supplied to the receiving unit 24 in order to obtain the information transmitted in the second reception signal.

As an alternative to a symmetrical first transmission and reception signal and an asymmetrical second transmission and reception signal according to the two transceiver arrangements 7 and 7′ in FIGS. 5A and 5B, an asymmetrical first transmission and reception signal and a symmetrical second transmission and reception signal are also conceivable.

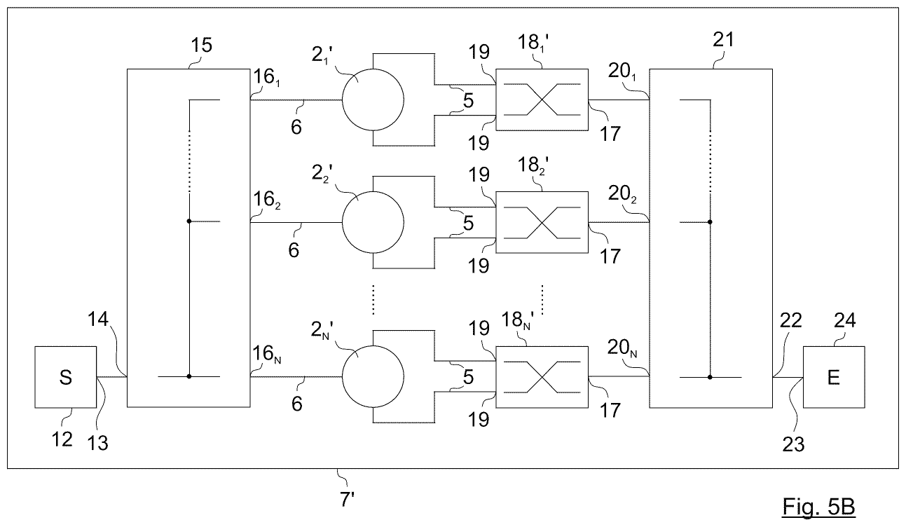

FIG. 6 shows an exemplary application of the antenna arrangement 1 according to the invention:

FIG. 6 shows an antenna system 2 l in which the antenna arrangement 1 according to the invention is combined with an antenna arrangement 26 according to EP 4 150 708 B1 on a common electrical printed circuit board 4. The antenna arrangement 26, which is arranged in the centre of the antenna system 25, has planar antennas which are known to be elliptically shaped and form a pair of transmitting antennas and a pair of receiving antennas arranged substantially orthogonally thereto. The antenna arrangement 1 according to the invention comprising, for example, eight planar antennas 2₁, 2₂, 2₃, 2₄, 2₅, 2₆, 2₇, 2₈ is arranged annularly around the antenna arrangement 26. A further annularly shaped layer 9 of absorber material can be formed between the antenna arrangement 1 according to the invention and the known antenna arrangement 26. Such an antenna system 25 can be used to realize wireless full-duplex data transmission in two transmission channels each with a different transmission protocol.

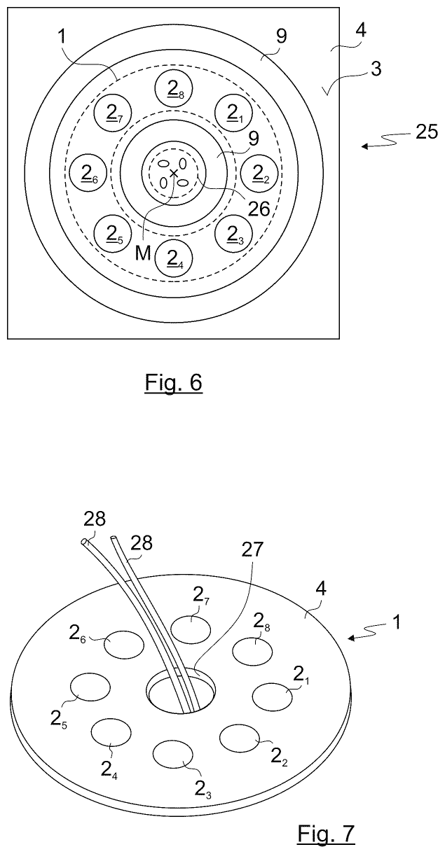

In a further application example of the antenna arrangement 1 according to the invention according to FIG. 7, the electrical printed circuit board 4, on which the antenna arrangement 1 comprising the annularly arranged planar antennas 2₁, 2₂, 2₃, 2₄, 2₅, 2₆, 2₇, 2₈ is formed, has a bushing 27 in its centre. Additional lines 28 can be routed through the bushing 27 of the electrical printed circuit board 4, which lines are used to transmit a medium such as a pneumatic or a hydraulic fluid or a higher energy, which cannot be transmitted wirelessly between two devices.

Although the present invention has been fully described above on the basis of preferred exemplary embodiments, it is not restricted to these and instead can be modified in a variety of ways.

1. An antenna arrangement having a centre axis (Z) and comprising a plurality of antennas which are each designed to emit a first electromagnetic wave and to simultaneously receive a second electromagnetic wave,
wherein each antenna of the plurality of antennas comprises a centroid (C) and is arranged around the centre axis (Z) of the antenna arrangement,
wherein associated centroids(S) of directly adjacent antennas are each arranged equidistantly from each other, wherein each antenna of the plurality of antennas is respectively coupled to at least one associated first signal line of the transceiver arrangement (a) electrically, (b) magnetically, or (c) via a combination thereof, and is also respectively coupled to at least one associated second signal line of the transceiver arrangement (a) electrically, (b) magnetically, or (c) via a combination thereof,
wherein, in each antenna of the plurality of antennas, the at least one associated first signal line is respectively oriented orthogonally to the at least one associated second signal line,
wherein, in each antenna of the plurality of antennas, the at least one associated first signal line and the at least one associated second signal line are designed for use either (i) in a first way where the at least one associated first signal line conducts a transmission signal for emitting the first electromagnetic wave and the at least one associated second signal line conducts a reception signal of the received second electromagnetic wave, or (ii) in a second way where the at least one associated first signal line conducts the reception signal of the received second electromagnetic wave and the at least one associated second signal line conducts the transmission signal for emitting the first electromagnetic wave.

2. The antenna arrangement of claim 1,
wherein, for each antenna of the plurality of antennas, either (a) the transmission signal is a symmetrical signal conducted by the associated two first signal lines, for use in the first way, or (b) the reception signal is the symmetrical signal conducted by the associated two first signal lines, for use in the second way;
wherein, each antenna of each pair of directly adjacent antennas, of the plurality of antennas, comprises a respective feed point for an associated symmetrical signa;
wherein the respective feed points of the directly adjacent antennas of each pair of directly adjacent antennas are arranged closely adjacent to each other within the respective pair of directly adjacent antennas; and
wherein each feed point of the directly adjacent antennas of each pair of directly adjacent antennas is configured for presenting a respective electrical potential of the associated symmetrical signal such that, in each pair of directly adjacent antennas, a phase of the associated symmetrical signal at one adjacent antenna is in phase opposition to a phase of the associated symmetrical signal at the other adjacent antenna; and
wherein (a) if the symmetrical signal is the transmission signal, the respective feed point for the associated first symmetrical signal of each antenna of each pair of directly adjacent antennas is a feed-in point, and (b) if the symmetrical signal is the reception signal, the respective feed point for the associated second symmetrical signal of each antenna of each pair of directly adjacent antennas is a feed-out point.

3. The antenna arrangement of claim 1, wherein, in each of the antennas, the at least one second signal line is respectively directed to the centroid of the respective antenna of the plurality of antennas.

4. The antenna arrangement of claim 1, wherein each antenna of the plurality of antennas has the same cross section in a direction orthogonal to the centre axis (Z).

5. The antenna arrangement of claim 1, wherein each antenna of the plurality of antennas is a planar antenna.

6. The antenna arrangement of claim 5, wherein each planar antenna is arranged either (a) on a first side surface of an electrical printed circuit board, along a common imaginary circumference relative to a centre point located at an intersection of the centre axis (Z) with the first side surface, or (b) on a first plane, along the common imaginary circumference relative to a centre point located at an intersection of the centre axis (Z) with the first plane.

7. The antenna arrangement of claim 1, wherein the plurality of antennas includes at least three antennas.

8. The antenna arrangement of claim 1, wherein the transmission signal is fed into each antenna, of the plurality of antennas, in phase, either by the at least one associated first signal line or by the at least one associated second signal line.

9. A transceiver arrangement comprising:
an antenna arrangement having a centre axis (Z) and comprising a plurality of antennas which are each designed to emit a first electromagnetic wave and to simultaneously receive a second electromagnetic wave,
wherein each antenna of the plurality of antennas comprises a centroid (C) and is arranged around the centre axis (Z) of the antenna arrangement,
wherein associated centroids(S) of directly adjacent antennas are each arranged equidistantly from each other,
wherein each antenna of the plurality of antennas is respectively coupled to at least one associated first signal line of the transceiver arrangement (a) electrically, (b) magnetically, or (c) via a combination thereof, and is also respectively coupled to at least one associated second signal line of the transceiver arrangement (a) electrically, (b) magnetically, or (c) via a combination thereof,
wherein, in each antenna of the plurality of antennas, the at least one associated first signal line is respectively oriented orthogonally to the at least one associated second signal line,
wherein, in each antenna of the plurality of antennas, the at least one associated first signal line and the at least one associated second signal line are designed for use either (i) in a first way where the at least one associated first signal line conducts a transmission signal for emitting the first electromagnetic wave and the at least one associated second signal line conducts a reception signal of the received second electromagnetic wave, or (ii) in a second way where the at least one associated first signal line conducts the reception signal of the received second electromagnetic wave and the at least one associated second signal line conducts the transmission signal for emitting the first electromagnetic wave;
a transmitting unit including an output terminal;
a receiving unit including an input terminal;
a signal branching unit including an input terminal and a set of output terminals; and
a signal combining unit including a set of input terminals and an output terminal;
wherein the output terminal of the transmitting unit is coupled to the input terminal of the signal branching unit and the output terminal of the signal combining unit is coupled to the input terminal of the receiving unit, and
wherein either (a) each output terminal of the set of output terminals of the signal branching unit is coupled to the at least one first signal line of an associated antenna of the plurality of antennas, and the at least one second signal line of each antenna of the plurality of antennas is coupled to an associated input terminal of the set of input terminals of the signal combining unit, or (b) each output terminal of the set of output terminals of the signal branching unit is coupled to the at least one second signal line of the associated antenna of the plurality of antennas, and the at least one first signal line of each antenna of the plurality of antennas is coupled to the associated input terminal of the signal combining unit.

10. The transceiver arrangement of claim 9, wherein either
(a) each output terminal of the set of output terminals of the signal branching unit is coupled to a respective asymmetrical terminal of a first balancing element associated with the respective antenna of the plurality of antennas, and a pair of first signal lines of the respective antenna of the plurality of antennas is connected to a respective pair of symmetrical terminals of the first balancing element, or
(b) a pair of first signal lines of each antenna of the plurality of antennas is respectively coupled to a pair of symmetrical terminals of a second balancing element associated with the respective antenna, and an associated input terminal of the signal combining unit is respectively coupled to an asymmetrical terminal of the second balancing element.

11. A communication system comprising:
a first transceiver arrangement and a second transceiver arrangement for providing wireless in-band full-duplex transmission between the two transceiver arrangements,
wherein each of the first transceiver arrangement and the second transceiver arrangement includes an antenna arrangement having a centre axis (Z) and comprising a plurality of antennas which are each designed to emit a first electromagnetic wave and to simultaneously receive a second electro-magnetic wave,
wherein each antenna of the plurality of antennas comprises a centroid (C) and is arranged around the centre axis (Z) of the antenna arrangement,
wherein associated centroids(S) of directly adjacent antennas are each arranged equidistantly from each other,
wherein each antenna of the plurality of antennas is respectively coupled to at least one associated first signal line of the respective transceiver arrangement (a) electrically, (b) magnetically, or (c) via a combination thereof, and is also respectively coupled to at least one associated second signal line of the transceiver arrangement (a) electrically, (b) magnetically, or (c) via a combination thereof,
wherein, in each antenna of the plurality of antennas, the at least one associated first signal line is respectively oriented orthogonally to the at least one associated second signal line,
wherein, in each antenna of the plurality of antennas, the at least one associated first signal line and the at least one associated second signal line are designed for use either (i) in a first way where the at least one associated first signal line conducts a transmission signal for emitting the first electromagnetic wave and the at least one associated second signal line conducts a reception signal of the received second electromagnetic wave, or (ii) in a second way where the at least one associated first signal line conducts the reception signal of the received second electromagnetic wave and the at least one associated second signal line conducts the transmission signal for emitting the first electromagnetic wave;
a transmitting unit including an output terminal;
a receiving unit including an input terminal;
a signal branching unit including an input terminal and a set of output terminals; and
a signal combining unit including a set of input terminals and an output terminal;
wherein the output terminal of the transmitting unit is coupled to the input terminal of the signal branching unit and the output terminal of the signal combining unit is coupled to the input terminal of the receiving unit,
wherein either (a) each output terminal of the set of output terminals of the signal branching unit is coupled to the at least one first signal line of an associated antenna of. the plurality of antennas, and the at least one second signal line of each antenna of the plurality of antennas is coupled to an associated input terminal of the set of input terminals of the signal combining unit, or
(b) each output terminal of the set of output terminals of the signal branching unit is coupled to the at least one second signal line of the associated antenna of the plurality of antennas, and the at least one first signal line of each antenna of the plurality of antennas is coupled to the associated input terminal of the signal combining unit,
wherein the first transceiver arrangement is configured to emit a first electromagnetic wave which belongs to a first transmission signal and the second transceiver arrangement is configured to receive the first electromagnetic wave and to convert the received first electromagnetic wave into an associated first reception signal, and
wherein the second transceiver arrangement is configured to emit a second electromagnetic wave which belongs to a second transmission signal and the first transceiver arrangement is configured to receive the second electromagnetic wave and to convert the received second electromagnetic wave into an associated second reception signal.

12. The communication system of claim 11,
wherein the centre axis (Z) of the first transceiver arrangement coincides with the centre axis (Z) of the second transceiver arrangement, and
wherein the two transceiver arrangements are rotatable relative to each other about a common axis of rotation (RA) which coincides with the respective centre axes of the two antenna arrangements.

13. The communication system of claim 11,
wherein the first transceiver arrangement comprises a first cylinder jacket and the second transceiver arrangement comprises a second cylinder jacket, and
wherein the first cylinder jacket, along which each antenna of the plurality of antennas of the first transceiver arrangement, is aligned with the second cylinder jacket, along which each antenna of the plurality of antennas of the second transceiver arrangement.

14. The communication system of claim 11;
wherein the first signal lines in the first transceiver arrangement each conducts the first transmission signal, the first signal lines in the second transceiver arrangement each conducts the associated first reception signal, the second signal lines in the second transceiver arrangement each conducts the second transmission signal, and the second signal lines in the first transceiver arrangement each conducts the associated second reception signal.

15. The communication system of claim 11,
wherein the first transceiver arrangement and the second transceiver arrangement are arranged in the near-field range with respect to each other, and
wherein an axial distance between the first transceiver arrangement and the second transceiver arrangement is less than 10 cm.

16. The antenna arrangement of claim 1, wherein each antenna of the plurality of antennas is arranged along a common imaginary cylinder jacket around the centre axis (Z).

17. The antenna arrangement of claim 4,
wherein, for each antenna of the plurality of antennas, a maximum extent in a direction radial to the centre axis (Z) of the antennas arrangement and a maximum extent in a direction tangential to the centre axis (z) of the antenna arrangement are preferably equal.

18. The antenna arrangement of claim 5,
wherein, each planar antenna is arranged either (a) on a side surface of an electrical printed circuit board, or (b) on a plane of the electrical printed circuit board parallel to the side surface.

19. The antenna arrangement of claim 8,
wherein the transmission signal is fed into each antenna, of the plurality of antennas, with equal amplitude.

20. The transceiver arrangement of claim 9,
wherein each antenna, of the plurality of antennas, is arranged along an imaginary cylinder jacket around the centre axis (Z).
